(19) United States
(12) Patent Application Publication
(10) Pub. No.: US 2006/0002258 A1
(43) Pub. Date: Jan. 5, 2006

(54) Method and apparatus for ejecting a medium

(76) Inventors: Takashi Nakamura, Iwaki-city (JP); Satoru Sekine, Iwaki-city (JP)

Correspondence Address: BRINKS HOFER GILSON & LIONE, P.O. BOX 10395, CHICAGO, IL, 60610, US

(21) Appl. No.: 11/165,611

(22) Filed: Jun. 23, 2005

(30) Foreign Application Priority Data
Jun. 24, 2004 (JP) 2004-185921

(51) Int. Cl. G11B 15/52

(52) U.S. Cl. 369/47.1

(57) ABSTRACT

An electronic apparatus and a method for ejecting a medium are provided that can ensure identification of eject keys for media even when the display of a touch panel surface is difficult to view. In the electronic apparatus, a touch panel 50 is slid to open a plurality of medium insertion/ejection ports 61 to 63, so that the predetermined medium (CD, DVD, MD) can be inserted therein and ejected therefrom. When the medium insertion/ejection port is opened, a touch panel surface is divided into areas, and the divisional areas SAR1 to SAR3 are allocated to touch switches EJK1 to EJK3 for ejection of the respective predetermined media. When the touch panel surface is touched, it is detected which touch switch is turned on, and then the medium corresponding to the touch switch turned on is ejected.

### BACKGROUND OF THE INVENTION

1. Field of the Invention

The present invention relates to an electronic apparatus and a method for ejecting a medium using the same. More particularly, the invention is directed to an electronic apparatus adapted to expose an insertion/ejection port for a medium to the outside by rotating a touch panel and to insert and eject the medium therein and therefrom, and to a method for ejecting the medium using the same.

2. Description of the Related Art

Vehicle-mounted multimedia apparatus may incorporate navigation, a radio reception, a television reception, a CD reproduction, an MD (mini disk) reproduction, and a DVD reproduction functions. Such a multimedia apparatus needs to be designed to conform to a predetermined size because it has to be accommodated in a small cabin space.

Minimizing the space taken up by such a multimedia electronic apparatus is often achieved by sharing a display device among the respective functions, or by incorporating a touch panel into a display device and altering an arrangement and indications of touch switches depending on the function so as to decrease the number of buttons and the like. The multimedia apparatus may be configured to include an insertion/ejection port for media, such as CD, DVD, or MD, with an operation panel including the touch panel, and to slide the front panel when inserting or ejecting the medium so as to expose (open) the medium insertion/ejection port to the outside, thereby inserting or ejecting the medium, as disclosed in JP-A-2002-324386.

FIG. 20 is a perspective view showing a multimedia apparatus including such a sliding structure of the panel when the panel is opened and closed. In detail, FIG. 20(A) illustrates a state of the closed panel, and FIG. 20(B) a state of the opened panel. As shown in FIG. 20(A), an operation panel 1 includes a touch panel 2 and various kinds of keys 3i, and is slidable with respect to an electronic apparatus body 4. The touch panel 2 consists of a liquid crystal display portion and a transparent touch panel portion integrally formed on the display, and thus has both functions of the display and the touch switch. Pressing the key for opening the panel, for example, a key 3₄, slides the operation panel from the closed state (A) to the opened state (B).

The body 4 is provided with a CD insertion/ejection port 5, an MD insertion/ejection port 6, and a DVD insertion/ejection port 7, as shown in FIG. 20(B), which are hidden behind the operation panel 1 not to be viewable when the operation panel 1 is closed. Further, the body is provided with a CD eject key 8, an MD eject key 9, and a DVD eject key 10, which are disposed next to the respective ejection ports for ejecting the medium. To insert a medium, for example, a CD disk, in the electronic apparatus body 4, the CD may be pushed from the CD insertion/ejection port 5 into the body. In contrast, to eject the medium, for example, the CD disk, from the body, the CD eject key 8 may be operated or pressed. This structure shown in FIG. 20, however, needs a great number of keys on the body, leading to disadvantages in its operability and cost.

For this reason, a method for decreasing the number of eject keys, such as the eject keys 8 to 10 shown in FIG. 20, has been proposed which involves using predetermined areas (inside circles) of the touch panel 2 as a touch switch 11 for ejecting the CD, a touch switch 12 for ejection the DVD, a touch switch 13 for ejecting the MD, and a touch switch 14 for closing the operation panel when opening the operation panel 1 as shown in FIG. 21.

The method as shown in FIG. 21, which involves forming the touch switches for ejection on the touch panel 2, has an advantage in decreasing the number of keys on the body. However, in this method, the touch panel 2 is faced upward in use as shown in FIG. 22, resulting in bad visibility of a liquid crystal display (LCD) portion due to outside light. This makes it difficult to identify areas (circular parts) which serve as the touch switches 11 to 14, especially during a clear day, disadvantageously failing to smoothly perform an eject operation.

### SUMMARY OF THE INVENTION

Accordingly, it is an object of the invention to provide an electronic apparatus that enables smooth ejection of a medium even on a crystal liquid display (LCD) with bad visibility.

Another object of the invention is to provide an electronic apparatus that can ensure identification of all eject keys for media even when the display on a touch panel surface is difficult to view.

The foregoing objects are accomplished according to one aspect of the invention, which provides an electronic apparatus for opening an insertion/ejection port for a medium by rotating a touch panel and for inserting and ejecting the medium. The apparatus comprises a controller for causing the touch panel to serve as a touch switch for ejection of the medium when the medium insertion/ejection port is opened, a touch-switch identification section for detecting a touch panel surface already touched and the touch switch being turned on, and a medium ejection section for ejecting the medium when the touch switch is turned on. The controller causes an entire surface of the touch panel to serve as the touch switch for ejection of the medium, and instructs the medium ejection section to eject the medium when the touch switch is turned on.

The foregoing objects are accomplished according to another aspect of the invention, which provides an electronic apparatus for opening a plurality of insertion/ejection ports for media by rotating a touch panel and for inserting and ejecting a predetermined medium in and from the corresponding port. The apparatus comprises a controller for dividing a surface of the touch panel into areas and allocating each of the divisional areas to a touch switch for ejection of a corresponding predetermined medium when the medium insertion/ejection ports are opened, a touch-switch identification section for detecting which one of the touch switches is turned on when the touch panel surface is touched, and a medium ejection section for ejecting the medium corresponding to the touch switch already turned on. The controller divides the touch panel surface into the at least n areas when the number of the medium insertion/ejection ports is n (n being an integer number of not less than two), and allocates each of the divisional areas to the touch switch for ejection of the medium from the corresponding predetermined medium insertion/ejection port. One divisional area is allocated to a close switch for closing the medium insertion/ejection port. If the medium is being reproduced when the medium insertion/ejection port is opened, the controller causes the entire surface of the touch panel to serve as the touch switch for ejection of the medium. If only one type of medium is inserted in the apparatus when the medium insertion/ejection port is opened, the controller causes the entire surface of the touch panel to serve as the touch switch for ejection of the medium.

The foregoing objects are accomplished according to a further aspect of the invention, which provides a method for ejecting a medium in an electronic apparatus which opens an insertion/ejection port for the medium by rotating a touch panel to insert and eject the medium. The method comprises the steps of rotating the touch panel by manipulating an open key to open the medium insertion/ejection port, switching the touch panel to a touch switch for ejection of the medium when the port is opened, and ejecting the medium when the touch panel surface is touched to turn on the touch switch.

The foregoing objects are accomplished according to a still further aspect of the invention, which provides a method for ejecting a medium in an electronic apparatus which opens a plurality of insertion/ejection ports for media by rotating a touch panel to insert and eject a predetermined medium in and from the corresponding port. The method comprises the steps of rotating the touch panel by manipulating an open key to open the medium insertion/ejection port, dividing a surface of the touch panel into areas to allocate each of the divisional areas to a touch switch for ejection of a corresponding predetermined medium when the medium insertion/ejection port is opened, detecting which one of the touch switches is turned on when the touch panel surface is touched, and ejecting the medium corresponding to the touch switch already turned on.

According to the embodiments described above, the entire surface of the touch panel may be used as an eject key(s), thereby surely identifying which type of medium corresponds to the eject key, even on a crystal liquid display (LCD) with bad visibility, thus resulting in a smooth eject operation of the medium.

### BRIEF DESCRIPTION OF THE DRAWINGS

FIG. 1(A) is a diagram for explaining a first preferred embodiment of the invention;

FIG. 1(B) is another diagram for explaining the first preferred embodiment of the invention;

FIG. 2 is a front view of an operation panel;

FIG. 3 is a diagram for explaining medium insertion/ejection when the panel is open;

FIG. 4 shows an example of division of a touch panel surface, and of allocation of touch switches for ejection;

FIG. 5 shows another example of division of a touch panel surface, and of allocation of touch switches for ejection;

FIG. 6 shows still another example of division of a touch panel surface, and of allocation of touch switches for ejection;

FIG. 7 shows a further example of division of a touch panel surface, and of allocation of touch switches for ejection;

FIG. 8 shows a still further example of division of a touch panel surface, and of allocation of touch switches for ejection;

FIG. 9 shows a yet further example of division of a touch panel surface, and of allocation of touch switches for ejection;

FIG. 10 is a diagram showing the configuration of a part of the electronic apparatus associated with the medium insertion/ejection;

FIG. 11 is a flowchart showing a medium ejection process;

FIG. 12 is a flowchart showing a medium insertion process;

FIG. 13 is another flowchart showing another medium ejection process;

FIG. 14 shows an example of a CD eject key on a screen;

FIG. 15 is a further flowchart showing a further medium ejection process;

FIG. 16 is a diagram showing an exemplary configuration of the electronic apparatus in a case where a frequency of insertion/ejection of a medium is taken into consideration, and the size of a divisional area corresponding to the medium with the low frequency is reduced;

FIG. 17 is a diagram showing an exemplary configuration of the electronic apparatus in a case where allocation of the divisional areas is switched based on whether a vehicle has a right- or left-hand steering wheel;

FIG. 18 is a diagram showing the configuration of the second preferred embodiment;

FIG. 19 is a flowchart showing a medium ejection process in the second embodiment;

FIG. 20(A) is a perspective view showing a conventional complex electronic apparatus including a panel sliding structure when the panel is close;

FIG. 20(B) is a perspective view showing the conventional complex electronic apparatus including the panel sliding structure when the panel is open;

FIG. 21 is a diagram for explaining a conventional example in which predetermined areas of a touch panel serve as touch switches for medium ejection; and

FIG. 22 is a diagram for explaining a problem in the conventional example shown in FIG. 21.

### DESCRIPTION OF THE PREFERRED EMBODIMENTS

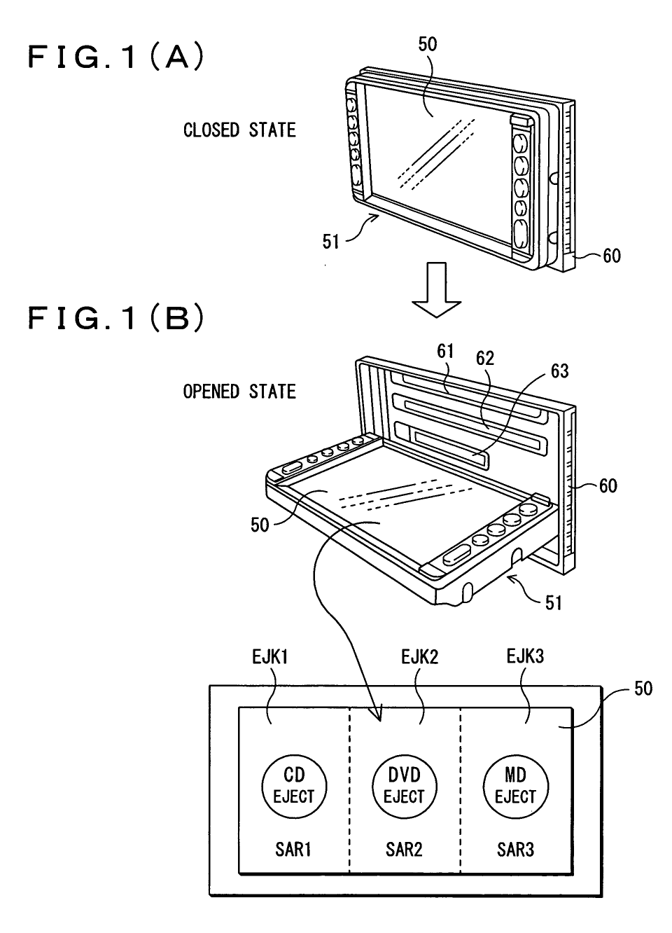

FIG. 1 is a diagram for explaining one preferred embodiment of the invention. When a predetermined medium (CD, DVD, or MD) is inserted into or ejected from an electronic apparatus, an operation panel 51 including a touch panel 50 is slid to open a plurality of medium insertion/ejection ports (a CD insertion/ejection port 61, a DVD insertion/ejection port 62, and an MD insertion/ejection port 63) provided in an electronic apparatus body 60. When the medium insertion/ejection ports are opened, the entire surface of the touch panel 50 is divided into areas. These divisional areas SAR1 to SAR3 are allocated to touch switches EJK1 to EJK3 for ejection of the predetermined media (CD, DVD, and MD). When the touch panel surface is touched, it is detected which touch switch is turned on, and then the medium corresponding to the touch switch already tuned on is ejected from a corresponding one of the medium insertion/ejection ports 61 to 63. That is, when the number of the medium insertion/ejection ports is n (n being an integer number of not less than two, e.g. n=3 in FIG. 1), the touch panel surface is divided into at least n areas, and the divisional areas SAR1 to SAR3 serve as the touch switches EJK1 to EJK3 for ejection of the CD, DVD, and MD.

### First Preferred Embodiment

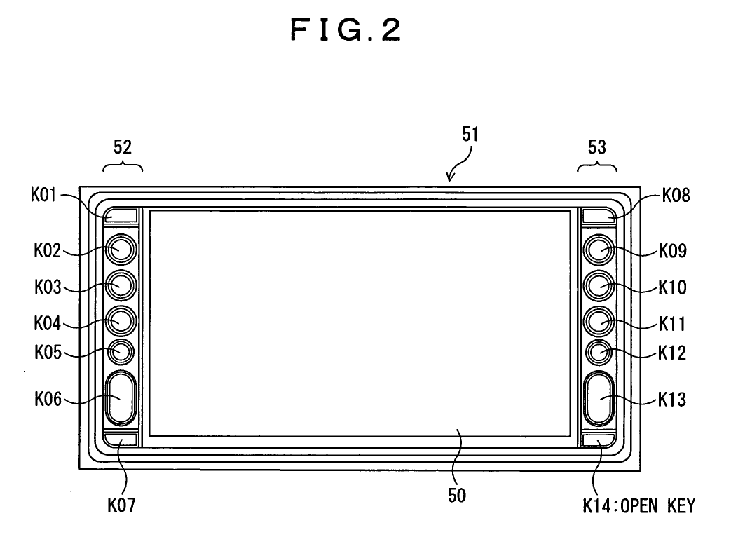

FIG. 2 is a front view of the operation panel 51, which is composed of the touch panel 50, and key portions 52 and 53 disposed on both sides thereof. The touch panel 50 consists of a liquid crystal display portion and a transparent touch panel portion attached on the display portion. On the liquid crystal display portion, are displayed a navigation map, operation screens for an audio, a television, a-DVD, and the like, characteristic information on FM teletext multiplex broadcasting, and the like. The key portions 52 and 53 are provided with various types of keys K01 to K14, which serve to input commands needed for power-up, mode switching, volume change, station selection, opening of the operation panel, and the like.

The key K14 is an open key for opening the operation panel 51. Pressing the key opens the operation panel 51 from a closed state shown in FIG. 1A to an opened state shown in FIG. 1B, so that the CD insertion/ejection port 61, the DVD insertion/ejection port 62, and the MD insertion/ejection port 63 are exposed to the outside.

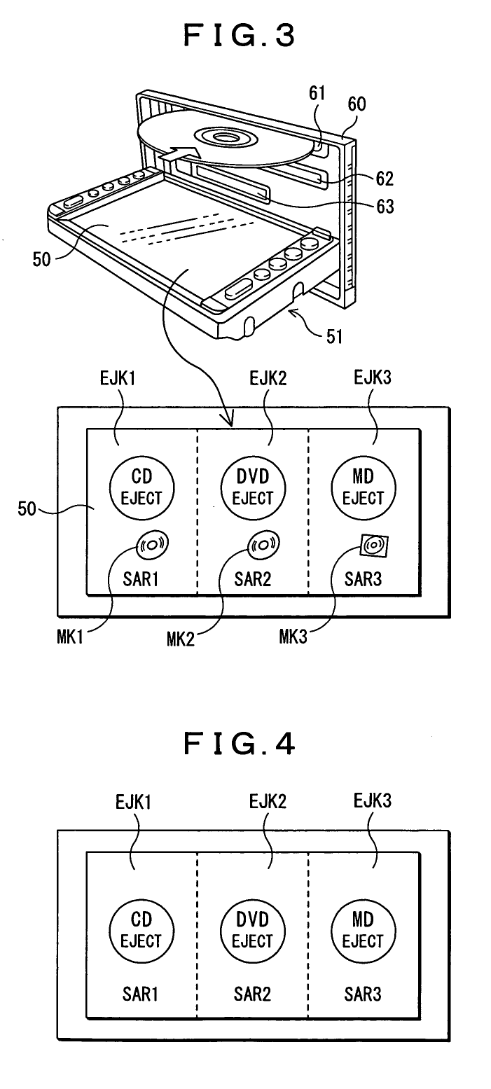

As shown in FIG. 3, when inserting a medium, a CD into the electronic apparatus when the panel is open, inserting and pressing the CD into the CD insertion/ejection port 61 is detected by a controller (not shown), so that the CD insertion/ejection mechanism is controlled to automatically pull the CD therein, and then to set it in the playing position. When the operation panel 51 is opened, the controller divides the entire surface of the touch panel 50 into areas, and allocates the areas obtained by the division, namely, the divisional areas SAR1 to SAR3, to the respective touch switches (eject keys) EJK1 to EJK3 for ejection of the CD, DVD, and MD. Thus, each of the divisional areas SAR1 to SAR3, in short, one third of the touch panel serves as each of the touch switches for ejection of the CD, DVD, and MD.

When the touch panel surface is divided laterally into the areas, an arrangement order of the medium insertion/ejection ports from the above (CD DVD MD) is related to an arrangement order of the divisional areas from a left side (SAR1 SAR2 SAR3), thereby providing the touch switch EJK1 for ejection of the CD, the touch switch EJK2 for ejection of the DVD, and the touch switch EJK3 for ejection of the MD, in this order from the left divisional area. This allocation of the respective divisional areas to the touch switches for ejection of the CD, DVD, and MD allows an operator to easily get a sense of the relationship between the medium insertion/ejection ports and the touch switches for the medium ejection. Further, if the CD, DVD, or MD is inserted when the operation panel 51 is opened, the corresponding one of the marks MK1 to MK3 indicative of “inserted” is displayed on the panel.

In order to eject a predetermined medium, the divisional area corresponding to the medium has only to be touched to turn on the corresponding one of the touch switches for ejection of the medium EJK1 to EJK3. When the touch panel surface is touched, the controller detects which one of the touch switches EJK1 to EJK3 is turned on, and drives the medium insertion/ejection mechanism corresponding to the touch switch turned on to eject the medium from the corresponding one of the medium insertion/ejection ports 61 to 63.

As mentioned above, one third of the touch panel serves as one of the touch switches for ejection of the CD, DVD, and MD, thus surely allowing a user to get a sense of the areas corresponding to the touch switches for ejection of the CD, DVD, and MD, even if the visibility of the liquid crystal display is deteriorated. This can eject the desired medium smoothly. The sense of the relationship between the medium insertion/ejection port and the touch switch for the medium ejection is easily gained, thereby enabling improvement in operational performance.

FIGS. 4 to 9 each show an example of division of the touch panel surface, and of allocation of the touch switches for ejection of the CD, DVD, and MD.

FIG. 4 illustrates an example in which the entire surface of the touch panel 50 is divided laterally into three areas, each with the same size, and these divisional areas SAR1 to SAR3 are allocated to the touch switches EJK1 to EJK3 for ejection of the CD, DVD, and MD, respectively, as in the case of FIG. 3. Note that no mark indicative of “inserted” is displayed in FIG. 4.

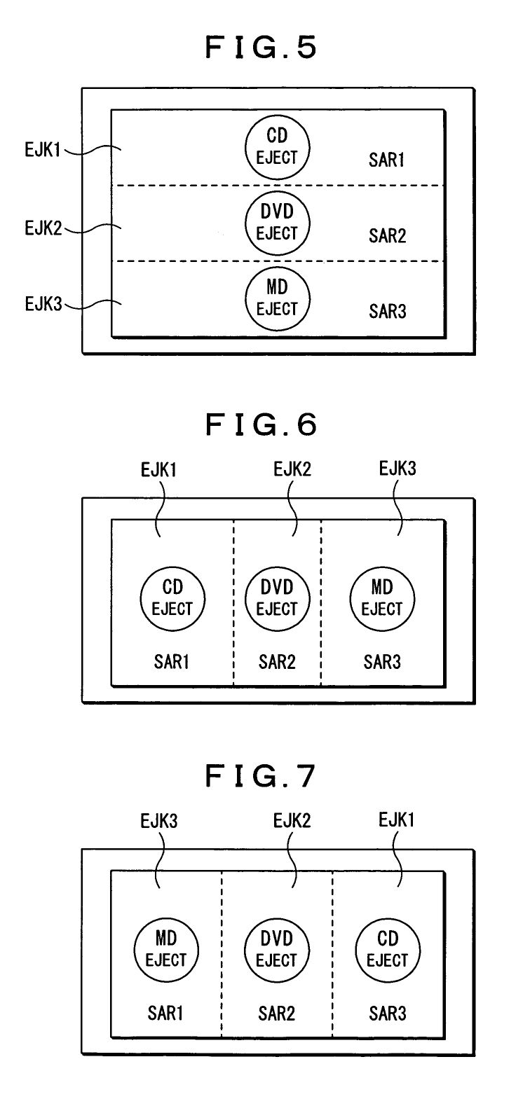

FIG. 5 illustrates an example in which the entire surface of the touch panel 50 is divided longitudinally into three areas, each with the same size, and these divisional areas SAR1 to SAR3 are allocated to the touch switches EJK1 to EJK3 for ejection of the CD, DVD, and MD, respectively. In FIG. 5, when the touch panel surface is divided longitudinally into the areas, an arrangement order of the medium insertion/ejection ports from an upper side (CD DVD MD) is related to an arrangement order of the divisional areas from an upper side (SAR1→SAR2→SAR3), thus providing the touch switch EJK1 for ejection of the CD, the touch switch EJK2 for ejection of the DVD, and the touch switch EJK3 for ejection of the MD, in this order from the upper divisional area. This allocation of the respective divisional areas to the touch switches for ejection of the CD, DVD, and MD allows an operator to easily get a sense of the relationship between the medium insertion/ejection ports and the touch switches for the medium ejection.

FIG. 6 illustrates an example in which the entire surface of the touch panel 50 is divided laterally into three areas, each differing in size, and these divisional areas SAR1 to SAR3 are allocated to the touch switches EJK1 to EJK3 for ejection of the CD, DVD, and MD, respectively. In FIG. 6, taking into consideration a frequency of insertion/ejection of the medium, the size of the divisional area is adjusted in such a manner that the size of the divisional area corresponding to the medium with the low frequency is reduced. For example, for an electronic apparatus in which a DVD disk installed is only a DVD for navigation maps, the frequency of insertion/ejection of the DVD is very low. Thus, the size of the divisional area for the DVD is reduced, while the sizes of the divisional areas for the CD and MD are increased or widen. This surely allows the user to get a sense of the areas corresponding to the touch switches for ejection of the CD and MD, even if the visibility of the liquid crystal display is deteriorated, thus resulting in smooth ejection of the desired medium.

FIG. 7 illustrates an example in which the entire surface of the touch panel 50 is divided laterally into three areas, each with the same size, and these divisional areas SAR1 to SAR3 are allocated to the touch switches EJK3 to EJK1 for ejection of the MD, DVD, and CD, respectively. That is, the allocation of the switches is opposite in direction to that shown in FIG. 4. In FIG. 4, assuming that the vehicle has a right-hand steering wheel, the touch switches for ejection of the CD, DVD, and MD are allocated in this order from the left divisional area. On the other hand, assuming that the vehicle has a left-hand steering wheel, taking its operability into consideration, the divisional areas SAR3 to SAR1 are preferably allocated to the touch switches EJK1 to EJK3 for ejection of the CD, DVD, and MD, respectively, in order to easily gain a sense of the relationship therebetween, thus resulting in improving the operational performance.

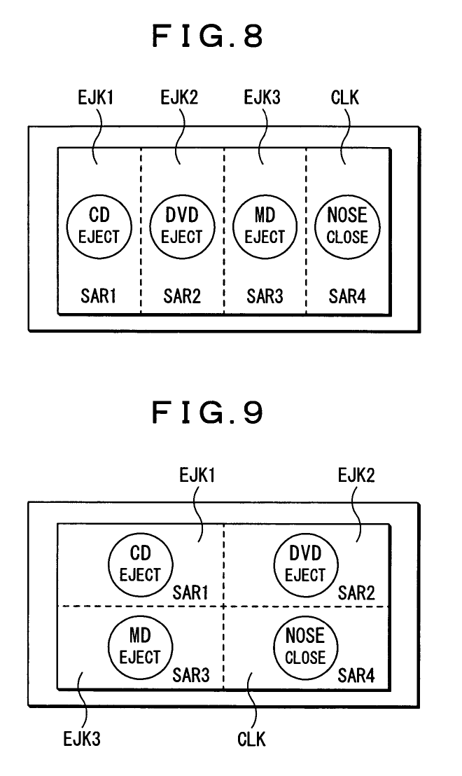

FIG. 8 illustrates an example in which the entire surface of the touch panel 50 is divided laterally into four areas, each with the same size, while these divisional areas SAR1 to SAR3 are allocated to the touch switches EJK1 to EJK3 for ejection of the CD, DVD, and MD, respectively, and the remaining divisional area SAR4 to a touch switch for close (close switch) CLK. This can eliminate a key for switching of the operation panel from an opened state to a closed state on the apparatus body, and can exhibit the same effect as that in the above case of the three divisional areas.

FIG. 9 illustrates an example in which the entire surface of the touch panel 50 is divided into four areas in a “Ta” shape of kanji character (or into a matrix), each with the same size, while these divisional areas SAR1 to SAR3 are allocated to the touch switches EJK1 to EJK3 for ejection of the CD, DVD, and MD, respectively, and the remaining divisional area SAR4 is allocated to the touch switch for close (close switch) CLK. The touch panel surface is recessed with each divisional area having a recessed edge. This surely allows the user to get a sense of the areas corresponding to the touch switches for ejection of the CD, DVD, and MD, even if the visibility of the liquid crystal display is deteriorated, thus resulting in smooth ejection of the desired medium. Note that the divisional area is not necessarily allocated to the close switch.

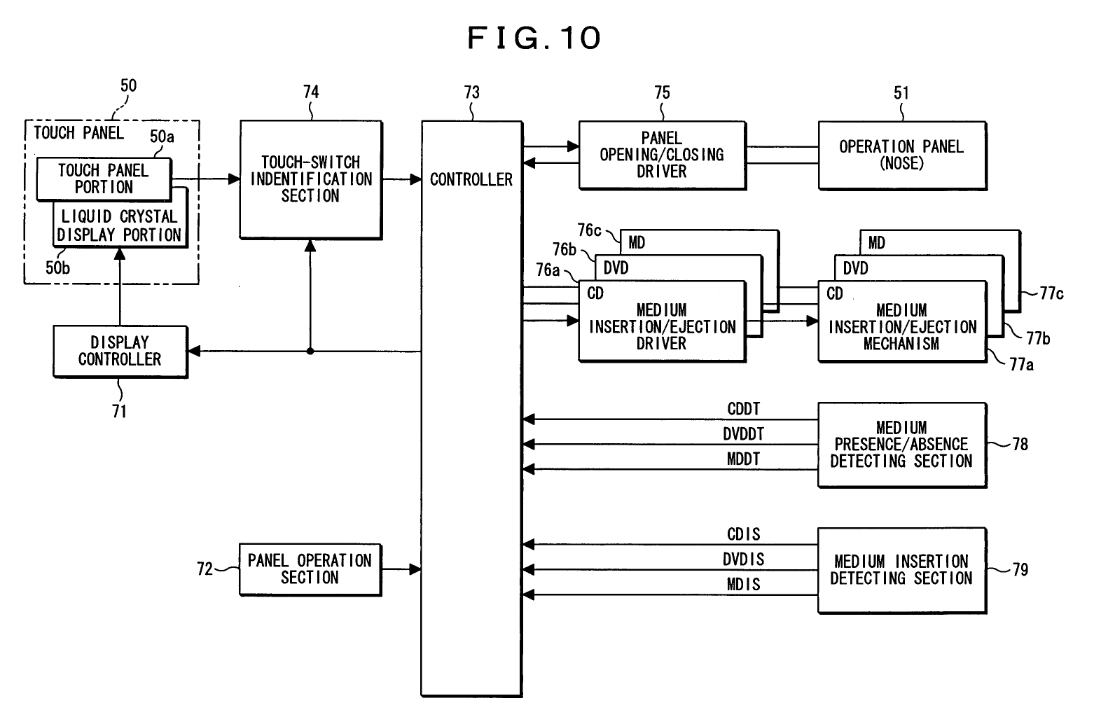

FIG. 10 is a diagram showing a main configuration of the electronic apparatus associated with the medium insertion/ejection process. The touch panel 50 consists of a liquid crystal display portion 50b and a transparent touch panel portion 50a attached thereto. On the liquid crystal display portion 50b, are displayed the navigation map, the operation screens for an audio, a television, a DVD, and the like, the characteristic information on FM teletext multiplex broadcasting, the eject-key screen (see FIGS. 3 to 9), and the like, under control of a display controller 71. A panel operation section 72 is provided with the keys K01 to K14 as explained in FIG. 2, from which predetermined commands are entered into a controller 73. A touch-switch identification section 74 identifies or determines which touch switch is turned on based on a touched position of the touch panel and a screen displayed on the display to enter the result into the controller 73. The controller 73 switches among the screens to be displayed on the liquid crystal display portion 50b, based on the inputs from the panel operation section 72 and the touch-switch identification section 74, and on the state of every component. And the controller 73 controls opening/closing of the operation panel, and insertion/ejection of the medium.

When the open key K14 is manipulated or pressed (see FIG. 2), a panel opening/closing driver 75 slides the operation panel 51 according to an instruction from the controller 73 to switch it from the closed state to the opened state as shown in FIG. 1. Further, when a close key (not shown), or the touch switch CLK as shown in FIG. 8 is turned on, the operation panel 51 is slid from the opened state to the closed state according to another instruction from the controller 73.

When a predetermined one of the touch switches EJK1 to EJK3 for ejection disposed on the touch panel is turned on, a corresponding one of the medium insertion/ejection drivers 76a to 76c for the CD, DVD, and MD drives one of medium insertion/ejection mechanisms 77a to 77c for the CD, DVD, and MD corresponding to the touch switch for ejection turned on according to the instruction from the controller 73 so as to eject the medium. When the medium (CD, DVD, or MD) is pushed into a corresponding one of the medium insertion/ejection ports 61 to 63, a corresponding one of the medium insertion/ejection drivers 76a to 76c drives one of the medium insertion/ejection mechanisms 77a to 77c according to the instruction from the controller 73, so that the medium is pulled therein and set in the reproduction position.

A medium presence/absence detecting section 78 detects whether the medium (CD, DVD, or MD) has been already set in the reproduction position or not, and then inputs medium presence/absence detection signals CDDT, DVDDT, and MDDT to the controller 73. The controller 73 appropriately displays the presence or absence of the medium on the touch panel based on the medium presence/absence detection signals CDDT, DVDDT, and MDDT. For example, marks MK1 to MK3 shown in FIG. 3 are displayed.

A medium insertion detecting section 79 detects the media (CD, DVD, and MD) being pushed in the apparatus from the medium insertion/ejection ports 61 to 63 to input the respective insertion detection signals CDIS, DVDIS, and MDIS to the controller 73. The controller 73 instructs each of the medium insertion/ejection drivers 76a to 76c to insert the corresponding medium therein based on the corresponding one of the insertion detection signals CDIS, DVDIS, and MDIS.

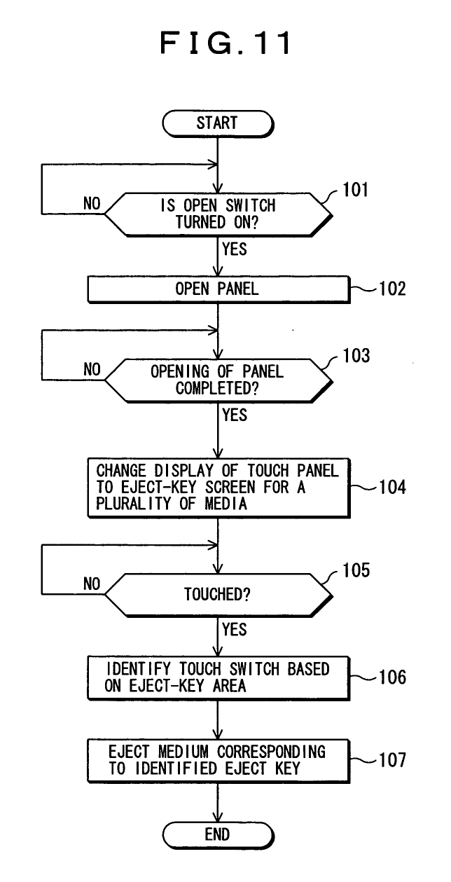

FIG. 11 is a flowchart showing a medium ejection process performed by the controller 73.

The controller 73 monitors whether the open switch K14 is operated or not (act 101). When the key is operated to provide an instruction to open the panel, the controller 73 controls the panel opening/closing driver 75 to slide the operation panel 51 from the closed state to the opened state as shown in FIG. 1 (act 102). When the open operation of the operation panel 51 is completed (act 103), the controller 73 switches the display of the touch panel 50 to a screen including a plurality of eject keys for the media, for example, a screen shown in FIG. 8 (act 104). Then, it is checked whether the touch panel is touched (act 105). If so, it is identified which one of the touch switches (eject keys) EJK1 to EJK3 is turned on (act 106). One of the medium insertion/ejection drivers 76a to 76c corresponding to the identified touch switch is controlled to eject the medium from the corresponding one of the medium insertion/ejection ports 61 to 63 (act 107).

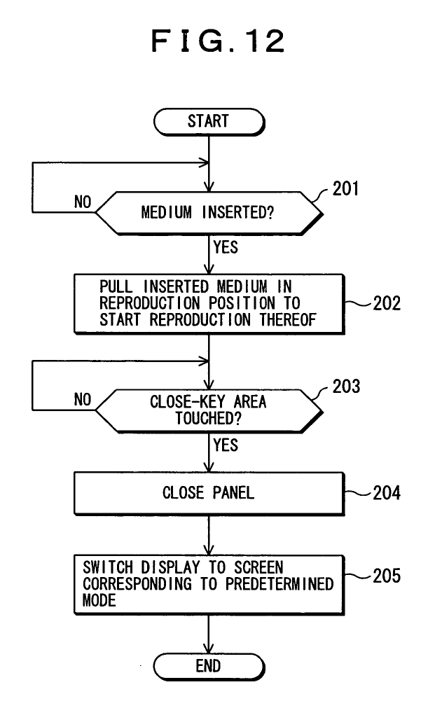

FIG. 12 is a flowchart showing a medium insertion process performed by the controller 73.

The controller 73 monitors whether a predetermined medium (CD, DVD, or MD) is pushed in the apparatus based on a signal inputted from the medium insertion detecting section 79 (act 201). If the medium is inserted in, the medium insertion/ejection driver 76a, 76b, or 76c corresponding to the medium is controlled such that the medium is set in the reproduction position, whereby reproduction of the medium is started (act 202). Then, it is monitored whether a touch key for close (close key) CLK on the touch panel is turned on (act 203). If it is turned on, the panel opening/closing driver 75 is controlled to slide the operation panel 51 into the closed state (act 204). Thereafter, the controller 73 switches the display of the crystal liquid display portion 50b to a screen corresponding to a predetermined mode, for example, to an operation screen of audio, a navigation map screen, or the like (act 205).

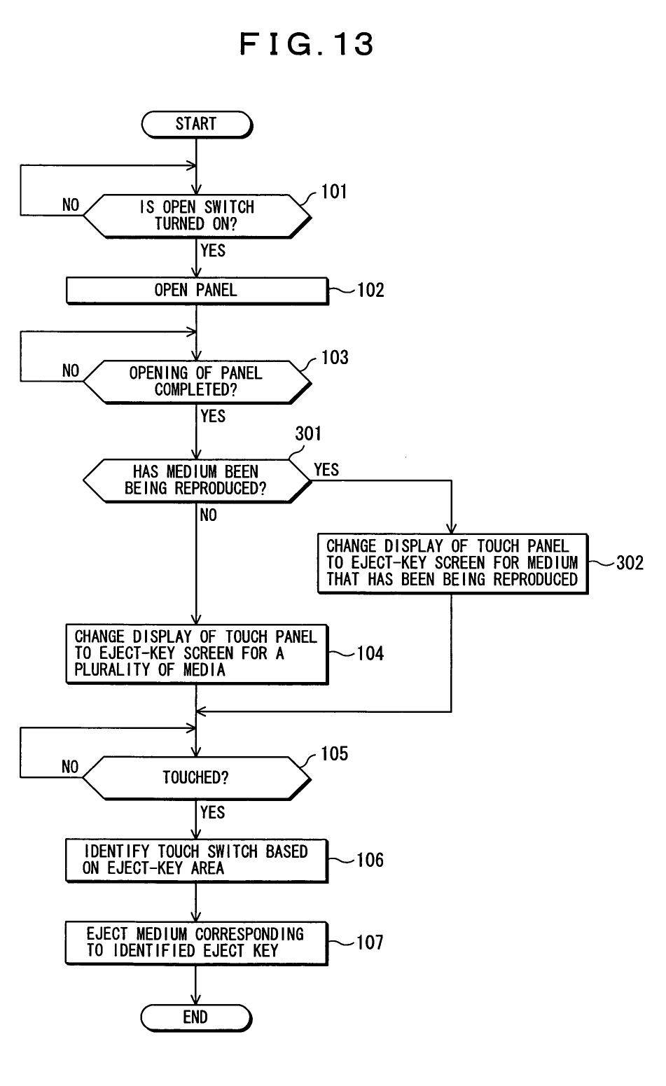

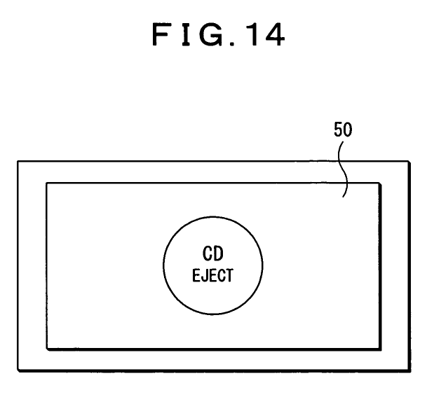

FIG. 13 is a flowchart showing another medium ejection process performed by the controller 73, wherein the acts 101 to 107 are the same as those in the flowchart of FIG. 11. If the opening of the operation panel is completed (act 103), it is checked whether the medium is being played when given the instruction to open the panel (act 301). If not, that is, if the medium has not been being reproduced, the same acts as those in FIG. 1 are carried out. If yes, that is, if the medium has been being reproduced, since the medium which has been being reproduced has the most possibility to be displaced, the display of the touch panel is switched to a screen having an eject key for the medium having been reproduced, for example, a CD eject-key screen as shown in FIG. 14 (act 302). Thereafter, when the touch panel is touched, the CD is ejected. As mentioned above, the entire surface of the touch panel serves as the touch switch for ejection of the CD, so that the CD can be surely ejected even on the liquid crystal display with bad visibility.

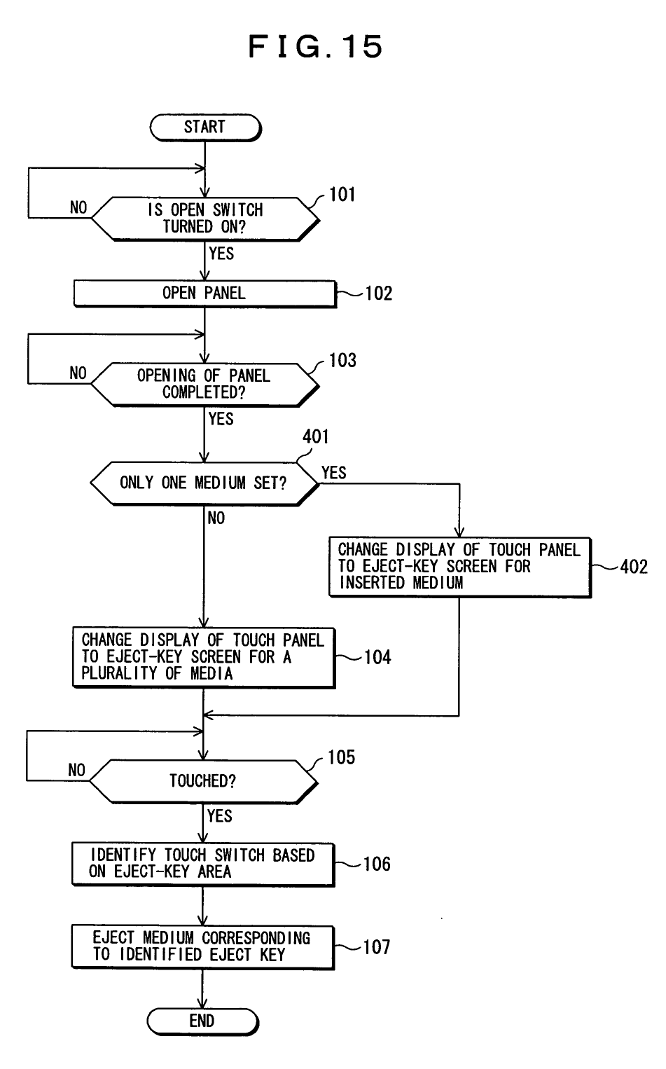

FIG. 15 is a flowchart showing a further medium ejection process performed by the controller 73, wherein the acts 101 to 107 are the same as those in the flowchart of FIG. 11. If the opening of the operation panel is completed (act 103), then it is checked whether only one medium is set in the playing position (act 401). If not, that is, if only one medium is not set in the position, the same steps as those in FIG. 11 are carried out. If yes, that is, if only one medium is set in the position, since the set medium is just to be ejected, the display of the touch panel is switched to the eject-key screen for the medium, for example, the CD eject-key screen as shown in FIG. 14 (act 402). Thereafter, when the touch panel is touched, the set CD is ejected. As mentioned above, the entire surface of the touch panel serves as the touch switch for ejection of the CD, so that the CD can be surely ejected even on the liquid crystal display with poor visibility.

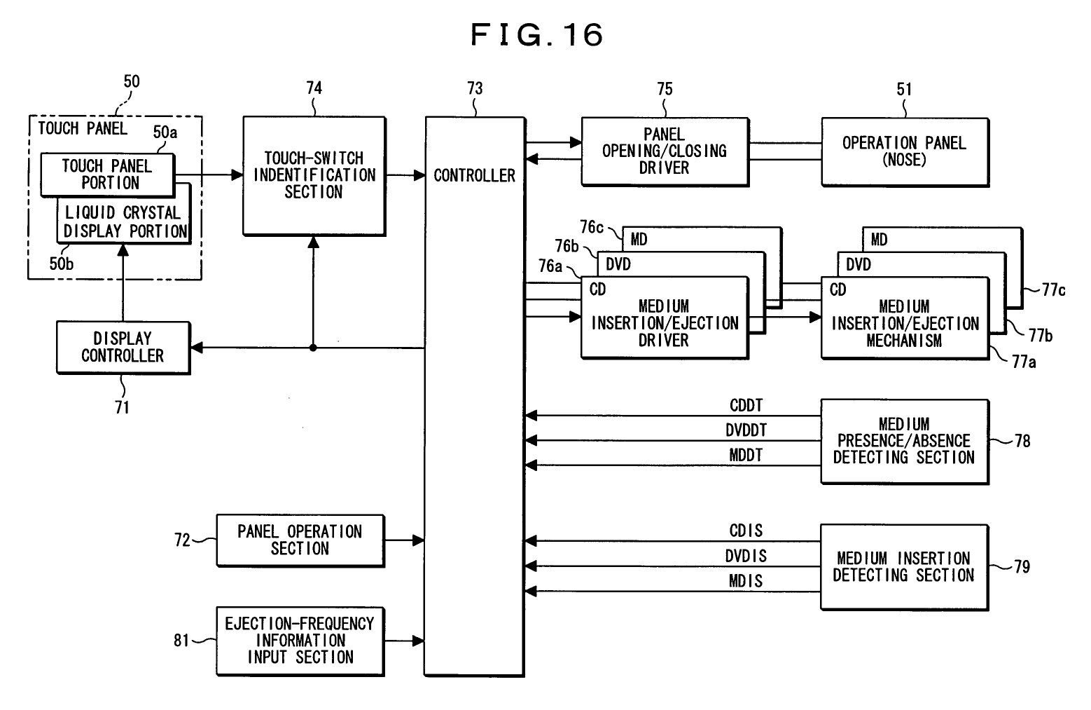

FIG. 16 is a diagram showing an exemplary configuration of the electronic apparatus in a case where a frequency of insertion/ejection of the medium is taken into consideration, and the size of a divisional area corresponding to the medium with the low frequency is reduced (see FIG. 6). The controller 73 determines the size of each divisional area on the eject-key screen based on information on the ejection frequency, which has been inputted from an ejection-frequency information input section 81 before shipment, and then displays each area on the eject-key screen in the size determined. Note that the size has been fixed since then.

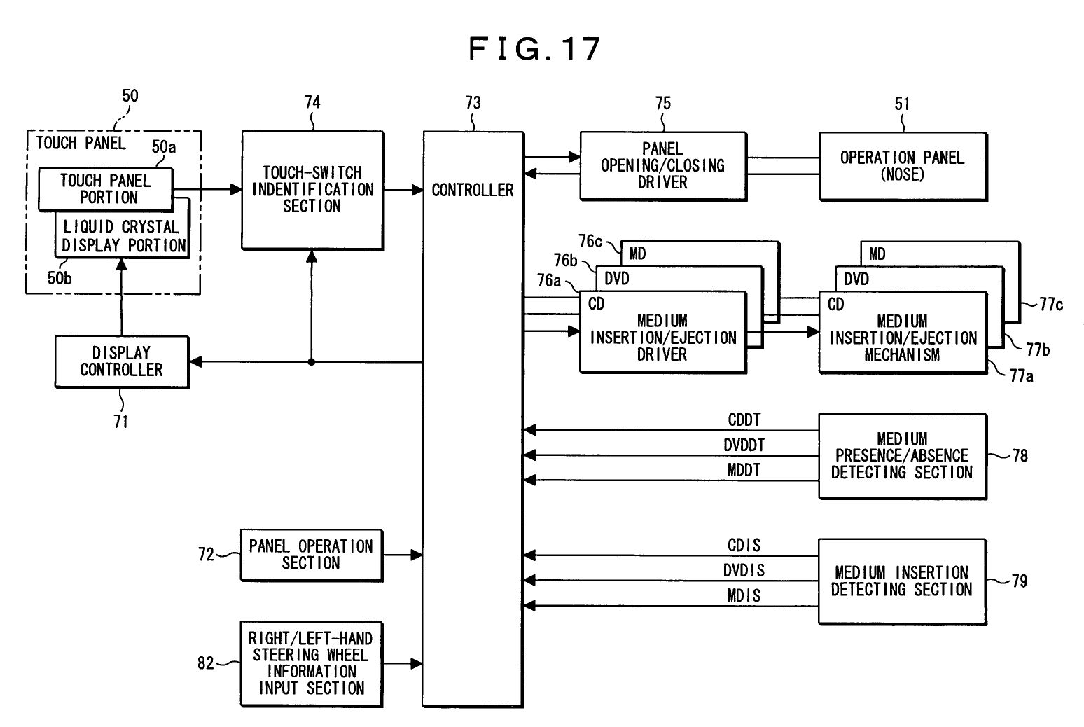

FIG. 17 is a diagram showing an exemplary configuration of the electronic apparatus in a case where allocation of the divisional areas is switched based on the right- or left-hand steering wheel (see FIGS. 4 and 7). The controller 73 determines the allocation of the divisional areas on the eject-key screen, based on handle information inputted from a right/left-hand steering wheel information input section 82 before shipment, and then displays the eject screen based on the determined allocation. Note that FIG. 4 illustrates the case of the vehicle with the right-hand steering wheel, while FIG. 7 the case of the vehicle with the left-hand steering wheel.

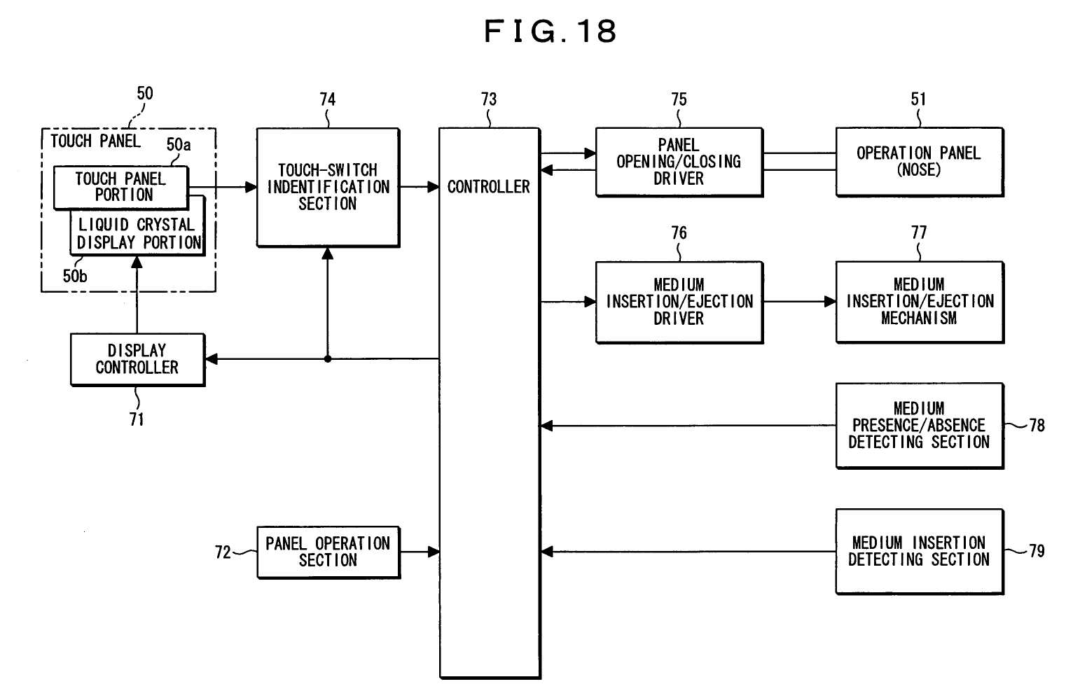

The electronic apparatus handling a plurality of types of media is exemplified in the previous embodiments, while an electronic apparatus handling one type of medium (for example, CD) is exemplified in this embodiment. In such a case, the entire or most of the touch panel surface serves as the touch switch for the CD ejection. FIG. 18 is a diagram showing the configuration of the second preferred embodiment, wherein elements that are in common to the first embodiment in FIG. 10 are given the same reference numerals. The difference from the first embodiment is that there are provided only one medium insertion/ejection driver 76 and only one medium insertion/ejection mechanism 77.

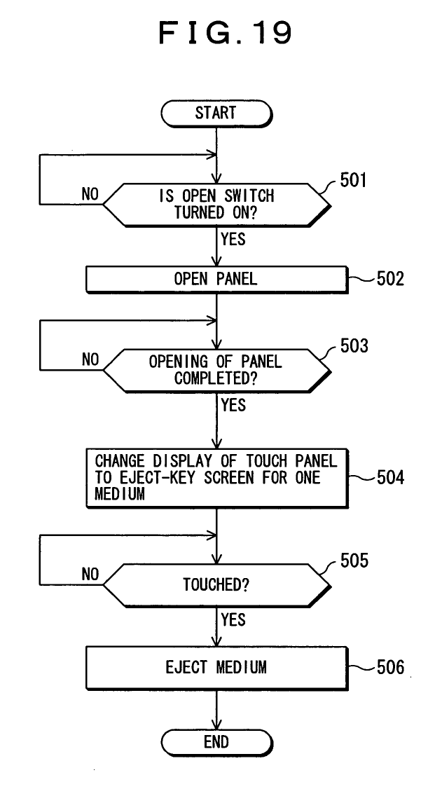

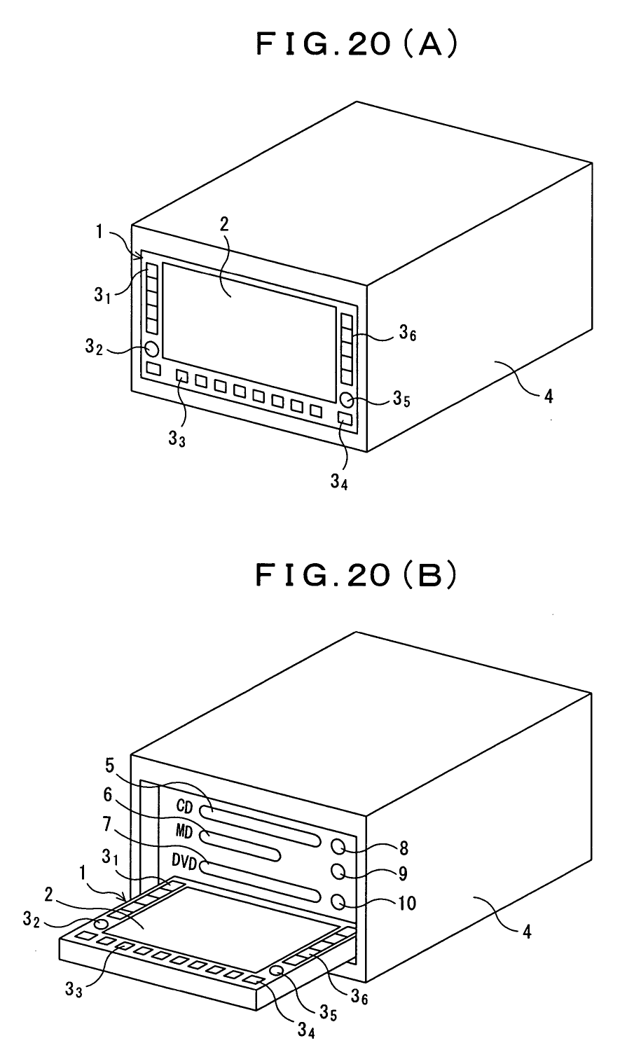

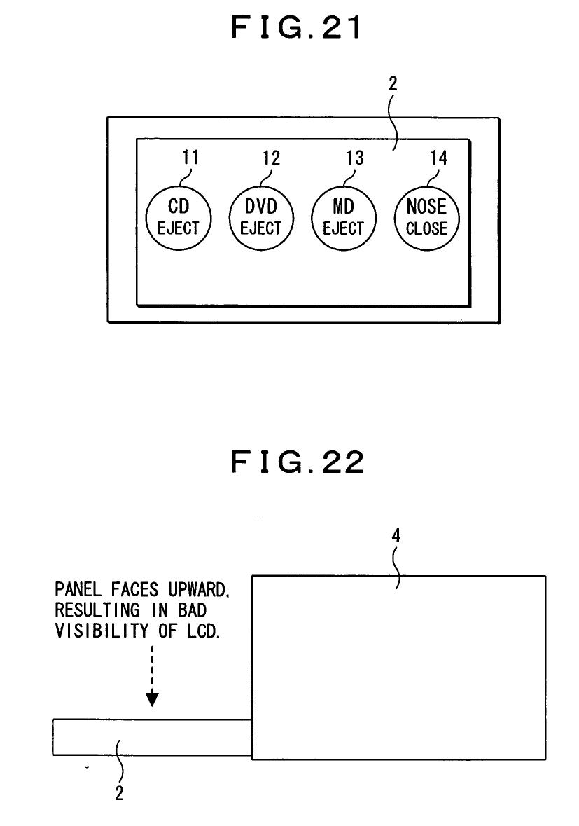

FIG. 19 is a flowchart showing a medium ejection process this second embodiment.

The controller 73 monitors whether the open switch K14 is operated or not (act 501). When the key is operated to provide an instruction to open the panel, the controller 73 controls the panel opening/closing driver 75 to slide the operation panel 51 from the closed state to the opened state (act 502). When the open operation of the operation panel 51 is completed (act 503), the controller 73 switches the display of the touch panel 50 to the eject-key screen (see FIG. 14) only for one medium (e.g. CD) (act 504). Then, it is checked whether the touch panel is touched (act 505). If yes, that is, if it is touched, the medium insertion/ejection driver 76 is controlled to eject the medium from the medium insertion/ejection port (act 506).

It should be noted that although, in the preferred embodiments as mentioned above, the media are the CD, DVD, and MD, the invention is not limited to such types and number of the media. The invention may be applied to any medium, such as a semiconductor recording medium or a cassette tape. Further, although the arrangement order of the medium insertion/ejection ports is CD→DVD→MD from the above in this order in the embodiments, the arrangement order is not limited thereto.

Moreover, although the above embodiments which involve sliding the touch panel have been explained above, the invention is not limited to such a sliding mechanism. The invention may take various types of configurations, including a configuration in which only an angle of the touch panel is changed without sliding the touch panel, more specifically, a configuration in which the touch panel is rotated around a predetermined rotation axis, or a configuration in which the panel surface is moved forward and then rotated.

It is to be understood that a wide range of changes and modifications to the embodiments described above will be apparent to those skilled in the art and are contemplated. It is therefore intended that the foregoing detailed description be regarded as illustrative, rather than limiting, and that it be understood that it is the following claims, including all equivalents, that are intended to define the spirit and scope of the invention.

1. An electronic apparatus for opening an insertion/ejection port comprising:
a controller operable to enable said touch panel surface to serve as a touch switch for ejection of the medium when the medium insertion/ejection port is opened;
a touch-switch identification section operable to detect a touch panel surface already touched and the touch switch being turned on; and
a medium ejection section operable to eject the medium when the touch switch is turned on.

2. The electronic apparatus of claim 1, wherein said controller enables the entire touch panel surface to serve as the touch switch for ejection of the medium, and instructs the medium ejection section to eject the medium when the touch switch is turned on.

3. The electronic apparatus of claim 1, wherein said controller enables a portion of touch panel surface to serve as the touch switch for ejection of the medium, and instructs the medium ejection section to eject the medium when the touch switch is turned on.

4. The electronic apparatus of claim 1, where the medium ejection section comprises a medium insertion/ejection drivers and a medium insertion/ejection mechanism.

5. An electronic apparatus for opening a plurality of insertion/ejection ports comprising:
a touch panel;
a plurality of insertion/ejection ports operable to receive and eject a medium;
a controller operable to divide a surface of the touch panel into areas and allocating each of the divisional areas to a touch switch for ejection of a corresponding predetermined medium when the medium insertion/ejection port is opened;
a touch-switch identification section operable to detect which one of the touch switches is turned on when the touch panel surface is touched; and
a medium ejection section operable to eject the medium corresponding to the touch switch turned on.

6. The electronic apparatus of claim 5 wherein the medium ejection section includes a plurality of insertion/ejection drivers and a plurality of medium insertion/ejection mechanisms.

7. The electronic apparatus of claim 5, wherein the controller divides the touch panel surface into said at least n areas when the number of the medium insertion/ejection ports is n, and allocates each of the divisional areas to the touch switch for ejection of the medium from the corresponding predetermined medium insertion/ejection port and wherein n is an integer greater than or equal to two.

8. The electronic apparatus of claim 7, wherein the touch panel surface is divided laterally into the areas and the controller arranges the order of the divisional areas to correspond to the arrangement of the medium insertion/ejection ports such that the first medium/ejection port corresponds to a left-most divisional area and subsequent ports have corresponding divisional areas to the right of the left-most divisional area.

9. The electronic apparatus of claim 7, wherein the touch panel surface is divided longitudinally into the areas and the controller arranges the order of the divisional areas to correspond to the arrangement of the medium insertion/ejection ports such that the first medium/ejection port corresponds to an uppermost divisional area and subsequent ports have corresponding divisional areas below the uppermost divisional area.

10. The electronic apparatus of claim 7, wherein the controller adjusts a size of the divisional area in such a manner that the size of the divisional area corresponding to the medium with a low ejection frequency is reduced.

11. The electronic apparatus of claim 7, wherein, when the touch panel surface is divided laterally into the areas, the controller relates the arrangement order of the medium insertion/ejection ports to the arrangement order of the divisional areas from the left side in the case of a vehicle with a right-hand steering wheel, or from the right side in the case of a vehicle with a left-hand steering wheel.

12. The electronic apparatus of claim 7, wherein one divisional area is allocated to a close switch for closing the medium insertion/ejection port.

13. The electronic apparatus of claim 7, wherein the controller divides the touch panel surface into a matrix, and allocates each of the divisional areas to the touch switch for ejection of the medium from the corresponding predetermined medium insertion/ejection port.

14. The electronic apparatus of claim 5, wherein, if the medium is being played when the medium insertion/ejection port is opened, said controller causes the entire surface of the touch panel to serve as the touch switch for ejection of said medium.

15. The electronic apparatus of claim 14, wherein the right divisional area is allocated to the close switch for closing the medium insertion/ejection port.

16. The electronic apparatus of claim 5, wherein, if only one type of medium is inserted in the apparatus when the medium insertion/ejection port is opened, said controller causes the entire surface of the touch panel to serve as the touch switch for ejection of said medium.

17. A method for ejecting a medium in an electronic apparatus which opens an insertion/ejection port for the medium by rotating a touch panel to insert and eject the medium, the method comprising the acts of:
rotating the touch panel by manipulating an open key to open the medium insertion/ejection port;
switching the touch panel to a touch switch for ejection of the medium when the port is opened; and
ejecting the medium when the touch panel surface is touched to turn on the touch switch.

18. The method of claim 17, wherein an entire surface of the touch panel is caused to serve as the touch switch for ejection of the medium.

19. A method for ejecting a medium in an electronic apparatus which opens a plurality of insertion/ejection ports for media by rotating a touch panel to insert and eject a predetermined medium in and from the corresponding port, the method comprising the acts of:
rotating the touch panel by manipulating an open key to open the medium insertion/ejection port;
dividing a surface of the touch panel into areas to allocate each of the divisional areas to a touch switch for ejection of a corresponding predetermined medium when the medium insertion/ejection port is opened;
detecting which one of the touch switches is turned on when the touch panel surface is touched; and
ejecting the medium corresponding to the touch switch turned on.

20. The method according to claim 19, further comprising the acts of dividing the touch panel surface into said at least n areas when the number of the medium insertion/ejection ports is n and allocating each of the divisional areas to the touch switch for ejection of the medium from the corresponding predetermined medium insertion/ejection port, wherein n is an integral greater than or equal to two.

21. The method of claim 19, further comprising the step of, if the medium is being reproduced when the medium insertion/ejection port is opened, causing the entire surface of the touch panel to serve as the touch switch for ejection of said medium.

22. The method of claim 19, further comprising the act of, if only one type of medium is inserted in the apparatus when the medium insertion/ejection port is opened, causing the entire surface of the touch panel to serve as the touch switch for ejection of said medium.
